(19) United States
(12) Patent Application Publication
(10) Pub. No.: US 2005/0036251 A1
(43) Pub. Date: Feb. 17, 2005

(54) Electrostatic discharge protection for trim-diodes

(75) Inventors: Shekar Mallikarjunaswamy, San Jose, CA (US); Charles Leonard Vinn, Milpitas, CA (US)

Correspondence Address: Eugene H. Valet;ValetPatents, 314 10th Avenue South, Edmonds, WA, 98020-3312, US

(73) Assignee: MICREL, Incorporated

(21) Appl. No.: 10/639,094

(22) Filed: Aug. 12, 2003

(51) Int. Cl. H02H 9/00

(52) U.S. Cl. 361/56

(57) ABSTRACT

An electrostatic discharge protection device connected in parallel with a trim-diode turns on during an electrostatic discharge event and conducts substantially all the current therefrom, yet remains inactive during diode trimming. An electrostatic discharge protection “snap-back” type device effectively turns on, diverting the electrostatic discharge current flow away from the trim-diode. Various exemplary embodiments are shown in both CMOS and Bi-CMOS technologies.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO AN APPENDIX

Not applicable.

### BACKGROUND

1. Technical Field

This disclosure relates generally to integrated circuits and more particularly to electrostatic discharge protection for trim-diodes.

2. Description of Related Art

Trim-diodes are typically used for trimming resistors or capacitors to precise values as required for specific integrated circuit designs. Conventional Zener trim-diodes, forward or reverse trimming, used for trimming resistors in band-gap circuits or resistors in voltage regulator outputs are typically connected in series or parallel to a resistor element that requires trimming and often are embedded in a string of resistor segments. FIG. 1a (Prior Art) illustrates a conventional trim diode circuit 100 schematic. An exemplary trimmed circuit element, resistor R1, is shown in phantom line as not being crucial to an explanation of the prior art nor the present invention. Conventionally, ESD protection is provided only on the circuit voltage supply pad 101, VCC, input pins and ground pins, e.g., by appropriately designed diodes or input resistors (not shown), but ESD protection is not provided for across the trim-diode 102. For trimming the operating characteristics of the trim-diode 102 a Driver 103 is used to apply power across the trim-diode. Because of its relatively small area in the integrated circuit silicon, the trim-diode 102 has a relatively much lower inherent capacitance C1 compared to the NMOS driver 103 inherent capacitance C2; e.g., typical range of C1/C2=0.1-to-0.01. During an ESD event onto the VCC pad 101, a voltage, +Ve, with respect to ground divides across the trim-diode and the NMOS driver depending upon there respective capacitance; therefore, since C1<<C2, almost all the ESD voltage +Ve, VCC-to-ground 104, appears across the trim-diode 102, generally causing device failure and destruction. Sense circuit 105 is a conventional, on-board, trimming device, imposing a voltage and comparing current across a reference compared to the trim diode as would be known in the art and used in post-package trimming of devices prior to shipping to customers. FIG. 1b (Prior Art) illustrates an example of such operating characteristics of the trim-diode 102 in reverse breakdown before, plot 212, and after, plot 211, trimming. Gate drive circuit 107 is a conventional, on-board, circuit which enables the NMOS driver 103 to turn ON which forces a high current through and voltage across the trim diode 102, causing its characteristics to change.

When pins of an integrated circuit device are subjected to an electrostatic discharge (“ESD”), +Ve, the high impedance of the input resistors generally protects the trim-diodes, forcing the current to flow through the associated ESD diodes connected to their respective pins. See e.g., U.S. Pat. No. 5,412,527 (Husher), assigned to the common assignee herein and incorporated herein by reference. However, for power integrated circuit devices, post-packaging trim techniques mandate that the trim-diode be connected in series with a power device that is required to source high current and voltage across the diode during trimming, such as illustrated by FIG. 1a. In such cases, the low capacitance of the trim-diode connected in series with the high capacitance of the power devices imposes serious ESD concerns when connected directly between supply and ground pads. During an ESD event between supply and ground pins, most of the voltage appears across the trim-diode, causing damage resulting in erroneous trimming.

Thus there is a need for a new technique for ESD protection for trim-diodes.

### BRIEF SUMMARY

The basic aspects of the invention generally relate to ESD protection for trim-diodes.

One aspect is a circuit for electrostatic discharge protection of a trim diode including: a trim diode, having a given breakdown voltage and given destruction voltage; and coupled in parallel with the trim-diode, a snap-back device wherein turn on voltage and snap-back voltage of the snap-back device during an electrostatic discharge event are less than the breakdown voltage and destruction voltage of the trim diode and said turn on voltage is greater than a voltage applied to said trim diode during trimming. Another aspect is an integrated circuit including: an input power pad; a power transistor drive circuit for driving a power transistor; connecting said input power pad and said power transistor drive circuit, a trim diode and a power transistor connected in series, wherein said trim diode has a cathode coupled to said input pad and an anode coupled to the a first terminal of said power transistor and said power transistor is connected via its other terminals between said power transistor drive circuit and electrical ground; and a snap-back device connected in parallel with said trim-diode, wherein said snap-back device is characterized by a snap-back voltage less than breakdown voltage of said trim-diode. Still another aspect is a method for protecting a trim-diode from electrostatic discharges, the method including: determining breakdown voltage of said trim diode; and connecting a snap-back device, having a snap-back voltage less than said breakdown voltage, in parallel with said trim diode. Yet a further aspect is a MOSFET integrated circuit including: an operating voltage input pad for said circuit; at least one trimming MOSFET having a drain region, a gate region, and a grounded source region; a gate drive circuit connected to said gate region; a trim diode having a predetermined breakdown voltage and having an anode connected to said drain region and a cathode connected to said pad such that said MOSFET and said trim-diode are series connected; and a snap-back device connected in parallel with said trim diode, wherein said snap-back device has a snap-back voltage less than said breakdown voltage such that during an electrostatic discharge onto said pad, wherein said snap-back device is off during trimming and turns on for protecting said trim diode from said electrostatic discharge.

The foregoing summary is not intended to be inclusive of all aspects, objects, advantages and features of the present invention nor should any limitation on the scope of the invention be implied therefrom. This Brief Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches.

### BRIEF DESCRIPTION OF THE DRAWINGS

FIG. 1a (Prior Art) illustrates a conventional trim diode circuit schematic.

FIG. 1b (Prior Art) is a graph showing trim-diode characteristic plots before and after trimming

FIG. 2 is a power driver circuit schematic in accordance with a first exemplary embodiment of the present invention.

FIG. 3 is a circuit schematic in accordance with a second exemplary embodiment of the present invention.

FIG. 4 is a circuit schematic in accordance with a third exemplary embodiment of the present invention.

FIG. 5 is a circuit schematic in accordance with a fourth exemplary embodiment of the present invention.

FIG. 6 is a circuit schematic in accordance with a fifth exemplary embodiment of the present invention.

FIG. 7 is a graph generally illustrating the operating characteristics of the snap-back device of the present invention as shown in FIGS. 2-6.

Like reference designations represent like features throughout the drawings. The drawings in this specification should be understood as not being drawn to scale unless specifically annotated as such.

### DETAILED DESCRIPTION

Generally, the embodiments of the present invention provide an ESD protection device connected in parallel with a trim-diode that turns on during an ESD event and conducts substantially all the current therefrom, yet remains inactive during diode trimming. This ESD protection, “snap-back” type, device turns on only due to the ESD event itself. Various exemplary embodiments are shown in both CMOS and Bi-CMOS technologies. While exemplary elements are discussed in detail, it will be recognized by those skilled in the art that specific implementations will vary depending on the specific design criteria for any specific integrated circuit implementation and their associated voltage/current requirements; no limitation on the scope of the invention is intended by the inventor by use of the following examples, nor should any be implied therefrom. Moreover, the invention also can be adapted for a plurality of power devices in bipolar technology.

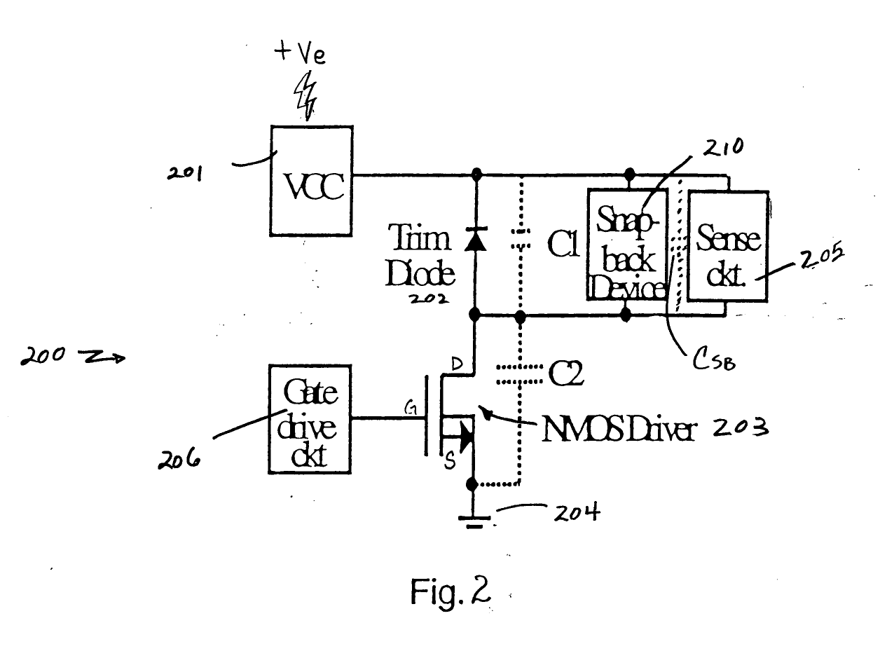

FIG. 2 is a circuit schematic in accordance with the present invention in CMOS technology, illustrating a NMOS circuit 200 having snap-back device 210 ESD protection for a trim-diode 202. It will be recognized by those skilled in the art that this is an illustration of just one of many elements of a complete integrated circuit device, or “chip.” FIG. 2 depicts the ESD protection device 210 in black-box form; later FIGURES will depict circuit element details for specific exemplary circuits for the snap-back device 210.

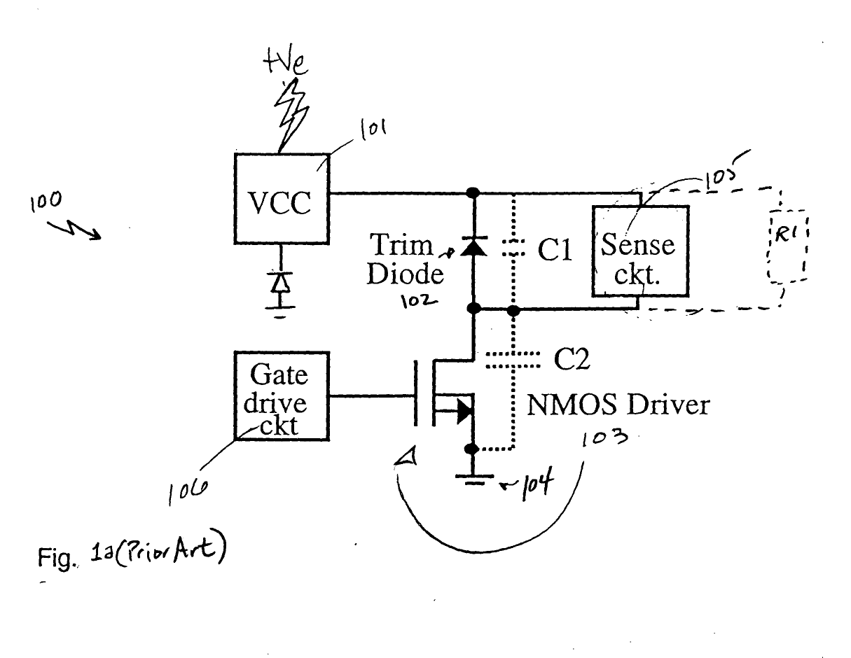

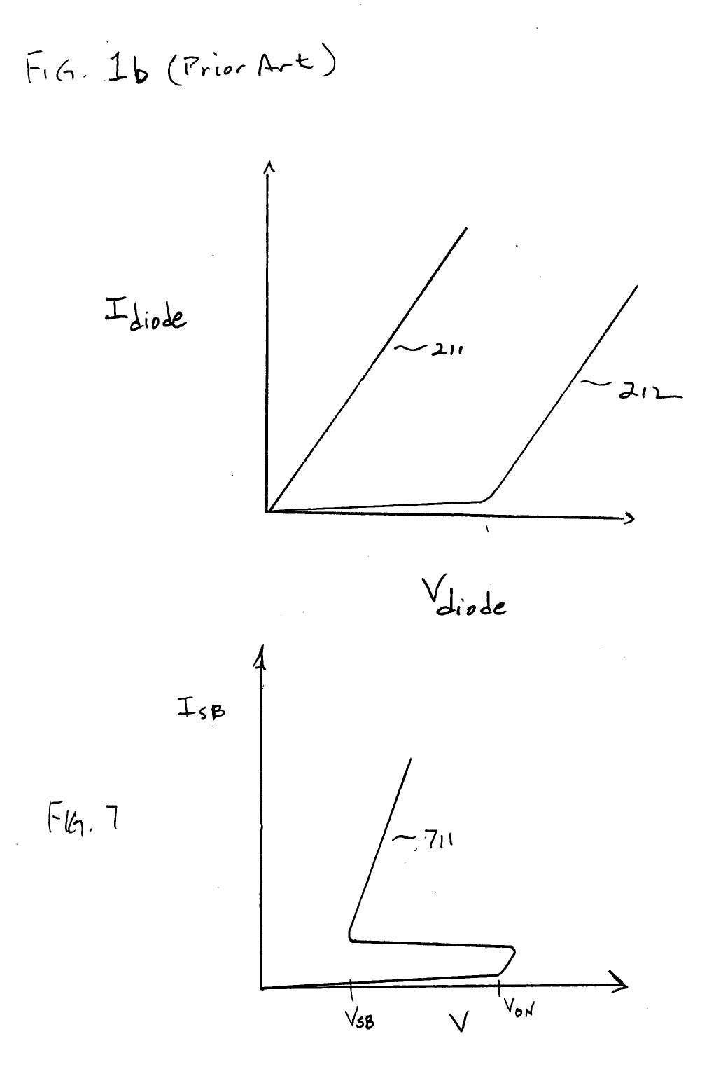

Conventionally in circuit 200, a trim-diode 202, e.g., a Zener or degenerate diode, having inherent capacitance C1 is connected in series with a field effect transistor (FET), NMOS Driver 203, having inherent capacitance C2, which provides the required current for reverse diode trimming. The trim-diode 202 has a relatively much lower inherent capacitance C1 compared to the NMOS Driver 203 inherent capacitance C2; e.g., typical approximate range of C1/C2=0.1-to-0.01. Symbol 204 is the convention for a ground node. Sense circuit 205 is a conventional, on-board, trimming device, imposing a voltage and comparing current across a reference with respect to that of the trim-diode 202 as would be known in the art, used in chip post-packaging trimming of devices prior to shipping to customers. For example, a METHOD AND APPARATUS FOR OPTIMIZING THE ACCURACY OF AN ELECTRONIC CIRCUIT is shown by David J. Kunst and Charles L. Vinn, inventor herein also, U.S. patent application Ser. No. 10/045,416, filed Oct. 26, 2001, assigned to the common assignee of the present application, and incorporated by reference. A trim determination circuit includes a measurable circuit element and determines the state of the measurable element. A replicate circuit includes a replicate circuit element which has similar electrical characteristics as the measurable element and is configured to aid in determining a adjustable test current. The trim determination circuit generates a test current which is proportional to the adjustable test current. The test current is passed through 6the measurable element such that a first voltage drop occurs across the measurable element. A measured current is generated at a current level dictated by the voltage drop across the measurable element such that the state of the measurable element is determined by the difference between the measured current and a scaled reference current. During post-packaging trimming, the required voltage is applied on VCC pad 201. Gate drive circuit 206 is a conventional, on-board, circuit coupled to the gate of the NMOS Driver 203 which enables it to turn ON, which forces a high current through and a voltage drop across the trim diode 202, causing its operating characteristics to change. As in the prior art described with respect to FIGS. 1a and 1b, the change in trim-diode operating characteristics is detected by the Sense circuit 205.

In general, the design of a snap-back device 210 can be implemented either as,
(1) a device of relatively low inherent capacitance, C_{SBL},—for example, where the approximate ratio C1/Csbl≧1 and the approximate size ratio of the GC-NMOS/NMOS DRIVER is ≦1—and relatively low snap-back voltage, V_{SB}, compared to the breakdown voltage, V_{B}, of the trim-diode 202, or
(2) a device of relatively high inherent capacitance, C_{SBH},—namely comparable to C2, FIG. 1—and relatively lower snap-back voltage compared to the breakdown voltage, V_{B}, of the trim-diode. In either implementation, the snap-back device 210 in parallel with the state of the measurable element is determined by the difference between the measured current and a scaled reference current. During post-packaging trimming, the required voltage is applied on VCC pad 201. Gate drive circuit 206 is a conventional, on-board, circuit coupled to the gate of the NMOS Driver 203 which enables it to turn ON, which forces a high current through and a voltage drop across the trim diode 202, causing its operating characteristics to change. As in the prior art described with respect to FIGS. 1a and 1b, the change in trim-diode operating characteristics is detected by the Sense circuit 205.

In general, the design of a snap-back device 210 can be implemented either as,
(1) a device of relatively low inherent capacitance, C_{SBL},—for example, where the approximate ratio C1/Csbl≧1 and the approximate size ratio of the GC-NMOS/NMOS DRIVER is ≦1—and relatively low snap-back voltage, V_{SB}, compared to the breakdown voltage, V_{B}, of the trim-diode 202, or
(2) a device of relatively high inherent capacitance, C_{SBH},—namely comparable to C2, FIG. 1—and relatively lower snap-back voltage compared to the breakdown voltage, V_{B}, of the trim-diode. In either implementation, the snap-back device 210 in parallel with the trim-diode 202 is effectively turned “ON” during an ESD event, directing most of the resultant current to ground 204 via snapping back to the relatively low snap-back voltage V_{SB} before the trim-diode gets damaged; see FIG. 7, curve 711. In general the snap-back voltage is preferably slightly less that the breakdown voltage of the trim-diode so that it will operate appropriately during an ESD event to protect the trim-diode, but will not interfere with the normal trimming operation voltage employed by the sense circuit. For example, if V_{B} is 9 volts and the trimming operation uses 6 volts, the snap-back voltage may be 7-8 volts.

In the first implementation, employing a snap-back device 210 of C_{SBL} and V_{SB} characteristics, during a +Ve ESD event, when a large ESD voltage, +Ve, occurs at the Vcc pad 201, substantially all of the voltage appears across the snap-back device 210. This causes the device 210 to snap into a lower voltage operating range, forcing substantially all the Vcc pad 201 current into the drain, D, of the NMOS Driver 203. Most of the ESD event voltage passes to the relatively high inherent capacitance, C2, of the NMOS Driver 203, protecting the trim-diode 202.

In the second implementation, employing a snap-back device 210 of C_{SBH} and V_{SB} characteristics, during a +Ve ESD event, then the voltage across the Vcc pad 201 is divided across C1+C_{SBH} and C2. Under these conditions, the ESD current will be forced to conduct through conventional ESD-diodes or resistors on the Vcc pin to ground 204 described in the Background section hereinbefore with respect to FIG. 1a and not through the snap-back device 210 path nor through the trim-diode 202, again protecting it from ESD event damage.

In other words, during an ESD event at the VCC pad 201, voltage +Ve with respect to ground does not divide across the trim diode 202 and the NMOS Driver 204 depending upon their respective capacitance values as with the prior art as seen FIG. 1a, Background section. Instead, during the ESD event, the snap-back device 210 effectively turns ON, diverting the majority of the ESD current to ground 204 before the trim-diode 202 can be damaged.

A specific ESD-protected circuit 300 design embodiment is shown in FIG. 3 wherein a snap-back device 210₁ having relatively low capacitance C_{SBH} and low snap-back voltage V_{SB} is employed. In this embodiment, the snap-back device 210₁ is implemented in CMOS technology, with a P-epitaxial layer or a P-substrate, as a grounded-body NMOS FET 311 connected in parallel with the trim-diode 202. It should be recognized that other implementation such as, in general, in BiCMOS, with an N-epitaxial layer, P-well and buried isolation region. The NMOS FET 311 is gate-coupled, GC-NMOS. The body region, also referred to in the art as the channel region beneath the gate G₃₁₁, is coupled to ground 204. The gate G₃₁₁ is coupled to the GC-NMOS FET source region S₃₁₁ via a relatively large resistor 312. In a test embodiment implemented in a 0.5 micron CMOS integrated device having a six volt VCC, a ten-thousand ohm resistor 212 was employed. The source region S₃₁₁ is coupled to an anode of the trim-diode 202. The snap-back device 210₁ GC-NMOS FET 311 source S₃₁₁ region is coupled to the drain D₂₀₃ region of the NMOS Driver 203; the GC-NMOS FET 311 drain D₃₁₁ region is coupled to the Vcc pad 201 and the cathode C of the trim-diode 202.

In operation, during an ESD event to the circuit 300, the drain-to-gate capacitance of the GC-NMOS FET 311 pulls up the gate of the GC-NMOS FET, causing the snap-back device 210₁ to turn ON, snapping back to a lower voltage than its regular breakdown voltage. This is illustrated by the plot in FIG. 7, where current through the snap-back device 210 is shown on the vertical axis, “I_{SB},” and voltage across the snap-back device 210 is shown on the vertical axis “V.” Again, all of the ESD event current is thus channeled away from the trim-diode 202, and through the GC-NMOS FET 311, protecting the trim-diode from damage by forcing the ESD voltage onto the inherent capacitance C2 (FIG. 1a) of the NMOS Driver 203. In other words, now the grounded body GC-NMOS FET 211 takes the ESD event +Ve rather than relatively low capacitance C1 (FIG. 1a) of the trim-diode 202.

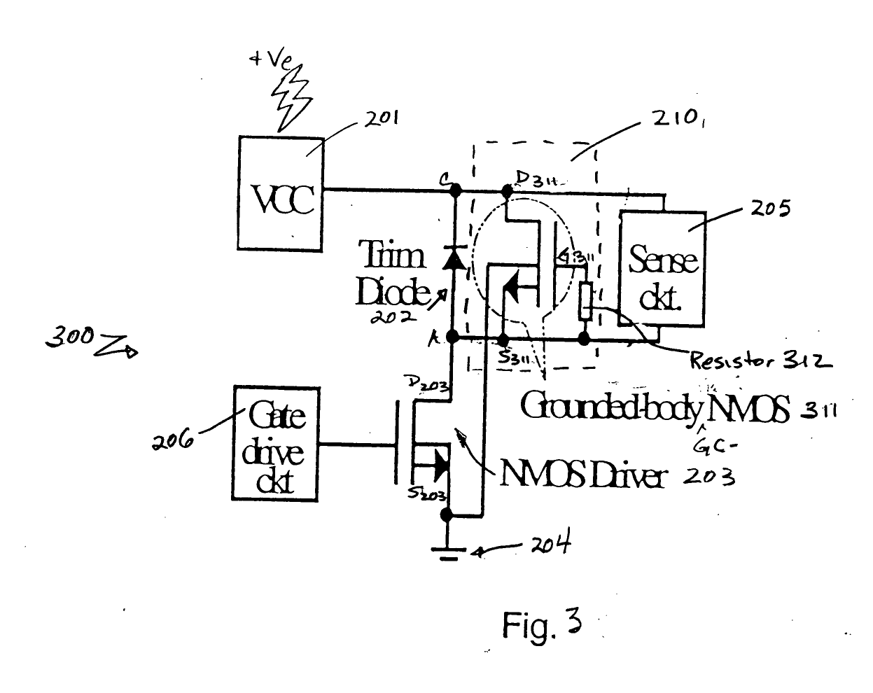

In another specific, exemplary, ESD-protected circuit 400 embodiment shown in FIG. 4, the ESD voltage, +Ve, onto the Vcc pad 201 is divided across a high capacitance C_{SB} of the snap-back device 210₂ and C2 (FIG. 1a). In this embodiment, the snap-back device is not a true “snap-back” as that term is conventionally used by those skilled in the art, but is a Zener or avalanche diode 401. It is referred to here as a “snap-back diode” 401 for consistency of explanation of the present invention. The snap-back diode 401 is designed into the circuitry 400 to have a breakdown voltage, V_{ZB}, higher than the reverse trimming voltage, V_{RT}, of the trim-diode 202. In general, it has been found that an approximate ratio of V_{RT}/V_{ZB}˜2.5 may be employed, considering the previously discussed CMOS parameters, or tailored accordingly for other CMOS processes. Thus, in operation, during an ESD event, the snap-back diode 401 will effectively turn “ON” and channel the majority of the ESD event current to ground, protecting the trim-diode.

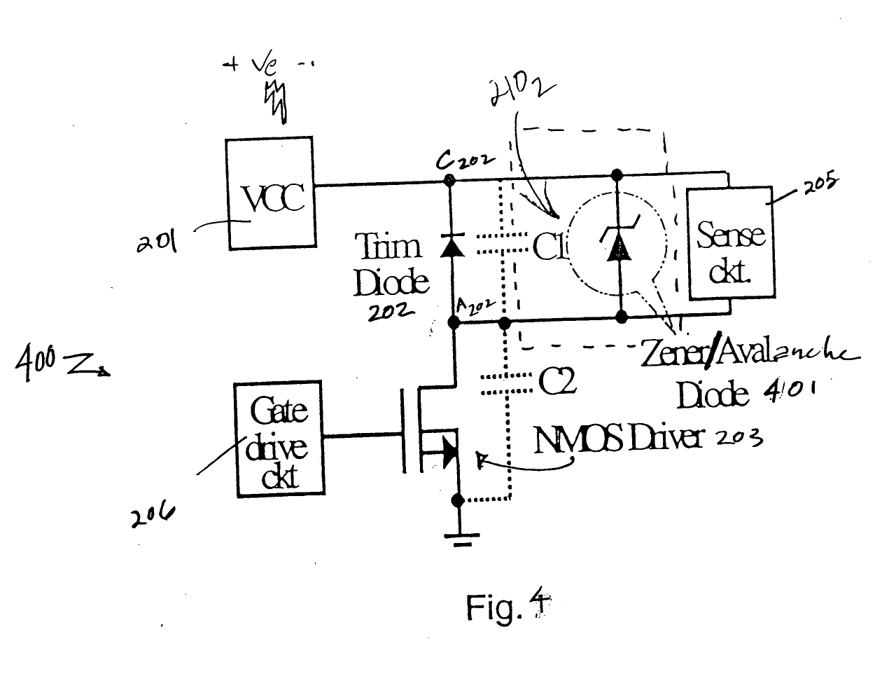

FIG. 5 illustrates another embodiment of the present invention, a circuit 500 implementation in Bi-CMOS technology. Here, the snap-back device 213₃ is a GC-NMOS FET 511 as in FIG. 4, but isolated in that the body is not tied electrically to ground. It will be recognized by those skilled in the art that the parasitic NPN transistor formed therein will turn ON during a ESD event to protect the trim-diode 202. The size of the isolated NMOS FET 511 is relatively smaller than that of the NMOS Driver 203, thus having a relatively low capacitance compared to that of the trim-diode 202. Thus, during an ESD event, the isolated GC-NMOS FET 511 turns ON and a majority of the current carried by it to the inherent capacitance C2 (FIG. 1) of the NMOS Driver 203 to protect the Trim Diode 202. The turn on voltage of the isolated GC-NMOS FET 511 can be reduced further by adding an additional capacitor (not shown) tying the drain D₅₁₁ and gate G₅₁₁ together electrically as long as the total capacitance does not interfere with the trimming process as described hereinbefore.

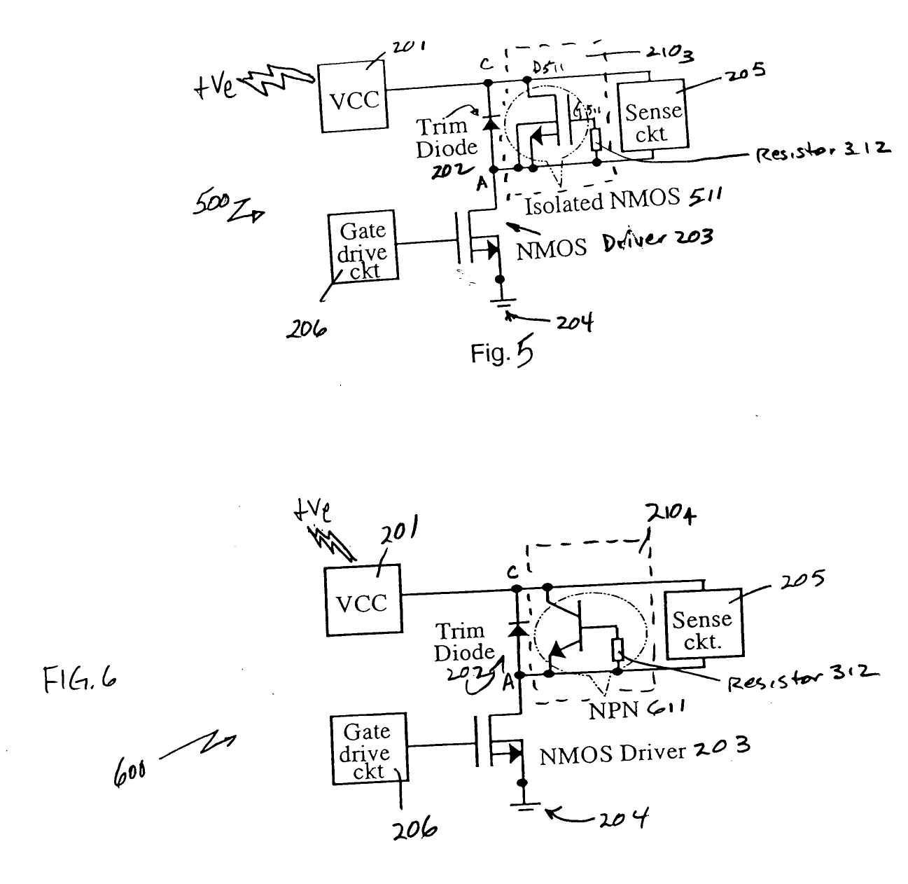

FIG. 6 is yet another embodiment of the present invention. In this Bi-CMOS circuit 600 implementation, a bipolar NPN transistor 611 in parallel with the trim-diode 202 is the snap-back device 210₄. Again, the NPN transistor 611 is appropriately sized in design to turn ON and snap-back to a voltage V_{SB} well below the breakdown voltage V_{B} of the trim-diode 202.

The foregoing Detailed Description of exemplary and preferred embodiments is presented for purposes of illustration and disclosure in accordance with the requirements of the law. It is not intended to be exhaustive nor to limit the invention to the precise forms described, but only to enable others skilled in the art to understand how the invention may be suited for a particular use or implementation. It should be specifically recognized that the invention is not limited to CMOS and Bi-CMOS process technologies and integrated circuits, but can be readily adapted to other forms such as SiGe Bi-CMOS, polysilicon emitter/base Bi-CMOS, bipolar and the like. The possibility of modifications and variations will be apparent to practitioners skilled in the art.

No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements during the term of the patent, and that adaptations in the future may take into consideration those advancements, in other word adaptations in accordance with the then current state of the art. It is intended that the scope of the invention be defined by the claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . . ”

1. A circuit for electrostatic discharge protection of a trim diode comprising:
a trim diode, having a given breakdown voltage and given destruction voltage; and
coupled in parallel with the trim-diode, a snap-back device wherein turn on voltage and snap-back voltage of the snap-back device during an electrostatic discharge event are less than the breakdown voltage and destruction voltage of the trim diode and said turn on voltage is greater than a voltage applied to said trim diode during trimming.

2. The circuit as set forth in claim 1 wherein said snap-back device has a relatively high inherent capacitance compared to inherent capacitance of said trim-diode such that said snap-back device forms a voltage divider.

3. The circuit as set forth in claim 1 wherein said snap-back device has a relatively low inherent capacitance compared to inherent capacitance of said trim-diode such that electrostatic discharge current is channeled to said snap-back device and away from said trim-diode.

4. An integrated circuit comprising:
an input power pad;
a power transistor drive circuit for driving a power transistor;
connecting said input power pad and said power transistor drive circuit, a trim diode and a power transistor connected in series, wherein said trim diode has a cathode coupled to said input pad and an anode coupled to the a first terminal of said power transistor and said power transistor is connected via its other terminals between said power transistor drive circuit and electrical ground; and
a snap-back device connected in parallel with said trim-diode, wherein said snap-back device is characterized by a snap-back voltage less than breakdown voltage of said trim-diode.

5. The circuit as set forth in claim 4 wherein turn on voltage and snap-back voltage of the snap-back device during an electrostatic discharge event are less than the breakdown voltage and destruction voltage of the trim diode and said turn on voltage is greater than a voltage applied to said trim diode during trimming.

6. The circuit as set forth in claim 4 comprising:
said power transistor is a MOSFET, and
said snap-back device is a grounded-body, gate-coupled MOSFET, having a drain region connected to a cathode of said trim-diode and a source region connected to an anode of said trim-diode.

7. The circuit as set forth in claim 6 comprising:
the grounded-body, gate-coupled MOSFET has a resistor connecting a gate region thereof to said source region thereof, the resistance of said resistor having a value for biasing said grounded-body, gate-coupled to a snap-back voltage substantially less than said breakdown voltage of said trim diode.

8. The circuit as set forth in claim 4 comprising:
said snap-back device is a Zener diode having its cathode connected to the cathode of said trim-diode and its anode connected to the anode of said trim-diode.

9. The circuit as set forth in claim 4 comprising:
said snap-back device is an gate-coupled, isolated-body MOSFET, having a drain region connected to a cathode of said trim-diode and its source region and body region connected to an anode of said trim-diode.

10. The circuit as set forth in claim 9 comprising:
the isolated-body, gate-coupled MOSFET has a resistor connecting a gate region thereof to said source region thereof, the resistance of said resistor having a value for biasing said isolated-body, gate-coupled to a snap-back voltage substantially less than said breakdown voltage of said trim diode.

11. The circuit as set forth in claim 4 comprising:
said snap-back device is a bipolar transistor having a collector connected to a cathode of said trim-diode, an emitter connected to an anode of said trim-diode, and a base connected via a biasing resistor to said emitter wherein said resistor has a resistance value for biasing said bipolar transistor to a snap-back voltage substantially less than said breakdown voltage of said trim diode.

12. A method for protecting a trim-diode from electrostatic discharges, the method comprising:
determining breakdown voltage of said trim diode; and
connecting a snap-back device, having a snap-back voltage less than said breakdown voltage, in parallel with said trim diode.

13. The method as set forth in claim 12 wherein turn on voltage and snap-back voltage of the snap-back device during an electrostatic discharge event are less than the breakdown voltage and destruction voltage of the trim diode and said turn on voltage is greater than a voltage applied to said trim diode during trimming.

14. A MOSFET integrated circuit comprising:
an operating voltage input pad for said circuit;
at least one trimming MOSFET having a drain region, a gate region, and a grounded source region;
a gate drive circuit connected to said gate region;
a trim diode having a predetermined breakdown voltage and having an anode connected to said drain region and a cathode connected to said pad such that said MOSFET and said trim-diode are series connected; and
a snap-back device connected in parallel with said trim diode, wherein said snap-back device has a snap-back voltage less than said breakdown voltage such that during an electrostatic discharge onto said pad, wherein said snap-back device is off during trimming and turns on for protecting said trim diode from said electrostatic discharge.

15. The circuit as set forth in claim 14 wherein turn on voltage and snap-back voltage of the snap-back device during an electrostatic discharge event are less than the breakdown voltage and destruction voltage of the trim diode and said turn on voltage is greater than a voltage applied to said trim diode during trimming.
